(19) United States
(12) Patent Application Publication
(10) Pub. No.: US 2004/0059848 A1
(43) Pub. Date: Mar. 25, 2004

(54) Device for automatically switching endian order

(75) Inventors: Chih-Sheng Chang, Taipei (TW); Wumin Chen, Taipei (TW); Chiuan-Yu Wei, Taipei (TW)

Correspondence Address: BACON & THOMAS, PLLC, 625 SLATERS LANE, FOURTH FLOOR, ALEXANDRIA, VA, 22314

(73) Assignee: Institute For Information Industry, Taipei (TW)

(21) Appl. No.: 10/251,977

(22) Filed: Sep. 23, 2002

(51) Int. Cl. G06F 13/12

(52) U.S. Cl. 710/65

(57) ABSTRACT

A device for automatically switching endian order is disclosed, which has an address decoder and an endain converter. The address decoder is used for receiving and decoding the address signal from a computer, thereby determining whether the decoded address is at a predefined memory space. Then, the endain converter switches the little-endain data or big-endian data if the decoded address is at a predefined memory space.

### BACKGROUND OF THE INVENTION

1. Field of the Invention

The present invention relates to a device for automatically switching endian order and, more particularly, to a device for automatically switching endian order between a computer and a peripheral device.

2. Description of Related Art

Due to the advance of the information technology and high-technique industry, many types of peripheral interface have been developed, for example, small computer system interface (SCSI), USB, IEEE1394, and PCMCIA, wherein the PCMCIA cards are widely used for notebook computer, PDA, and embedded system. The PCMCIA cards are either used for extending main memory, i.e., flash memory cards, or are used as the I/O interfaces to make a computer communicate with other peripheral interfaces.

However, it is possible to encounter an endian problem when the computer communicates with a peripheral interface by a PCMCIA interface in the embedded system. For example, the microprocessor adopts big-endian first in the embedded system, but the data stream that is sent by the PCMCIA interface adopts little-endian first.

A solution to eliminate the problem is to switch the endian order by a device driver, but it will waste external instruction cycle when it receives data, and thus the performance of the microprocessor is decreased significantly.

Therefore, it is desirable to provide an improved device to mitigate and/or obviate the aforementioned problems.

### SUMMARY OF THE INVENTION

The primary object of the present invention is to provide a device for automatically switching endian order in order to solve the endian error between computers and peripheral devices.

Another object of the present invention is to provide a device for automatically switching endian order between a computer and a peripheral device so as to reduce the external instruction cycle of the microprocessor thereby increasing the performance of the microprocessor.

To achieve the object, the there is provided a device for automatically switching endian order between a computer and a peripheral device. The computer has a microprocessor and a first register for temporarily storing the data that the microprocessor accessed. The peripheral device has a second register for accessing the peripheral device data. The computer accesses the peripheral device based on data signal, address signal, and control signal. The device for automatically switching endian order includes: an address decoder for receiving and decoding the address signal from the computer to determine whether the address to be accessed by the computer is at a predefined memory space; and an endian converter connected to the first register of the computer and the second register of the peripheral device for writing data stored in the first register to the second register, or writing data stored in the second register to the first register, wherein, when the address decoder determines that the address to be accessed by the computer is at the predefined memory space, the endian converter writes the little-endian and the big-endian of the first register to the big-endian and the little-endian of the second register, or writes the little-endian and the big-endian of the second register to the big-endian and the little-endian of the first register; otherwise, the endian converter writes the little-endian and the big-endian of the first register to the little-endian and the big-endian of the second register, or writes the little-endian and the big-endian of the second register to the little-endian and the big-endian of the first register.

Other objects, advantages, and novel features of the invention will become more apparent from the following detailed description when taken in conjunction with the accompanying drawings.

### BRIEF DESCRIPTION OF THE DRAWINGS

FIG. 1 shows the system structure using the device for automatically switching endian order of the present invention.

FIG. 2 schematically illustrates that a computer is communicated with a peripheral device in accordance with the present invention.

FIG. 3A shows the accessed addresses of the memory and the peripheral device in accordance with the present invention.

FIG. 3B shows an endian converter for switching the endian order of the data in accordance with the present invention.

FIG. 4 shows function block of the the device for automatically switching endian order in accordance with the present invention.

### DETAILED DESCRIPTION OF THE PREFERRED EMBODIMENT

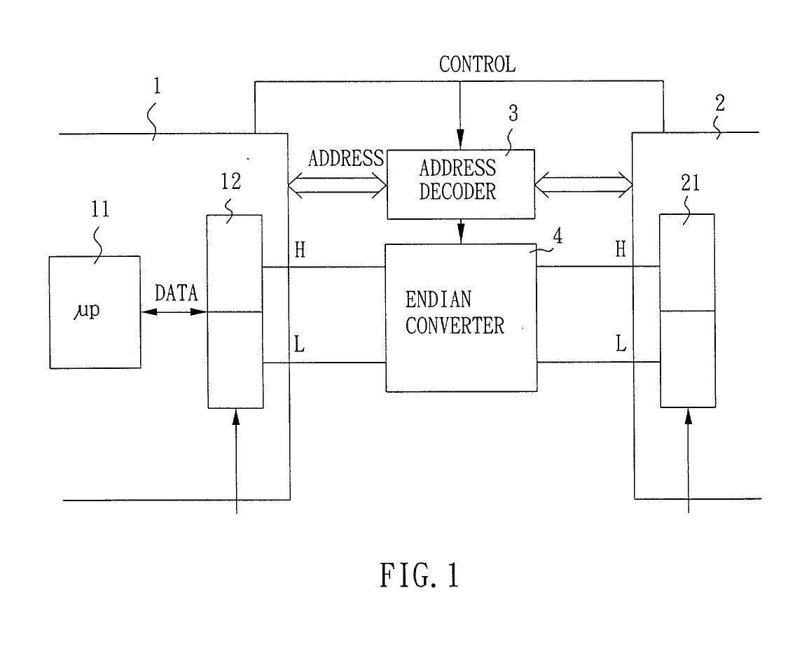

One preferred embodiment of the device for automatically switching endian order in accordance with the present invention will be described hereinafter. Referring to FIG. 1, there is shown a system architecture using the device for automatically switching endian order, which includes a computer 1, a peripheral device 2, an address decoder 3, and an endian converter 4. The computer 1 further has a microprocessor 11 and a first register 12, and the peripheral device 2 further has a second register 21.

In this embodiment, the computer 1 is preferably an embedded system computer; the peripheral device 2 is preferably an Ethernet card of the PCMCIA interface. The above microprocessor 11 is connected to the first register 12, and the address decoder 3 is connected to the computer 1 and the peripheral device 2. The endian converter 4 is connected to the first register 12 and the second register 21.

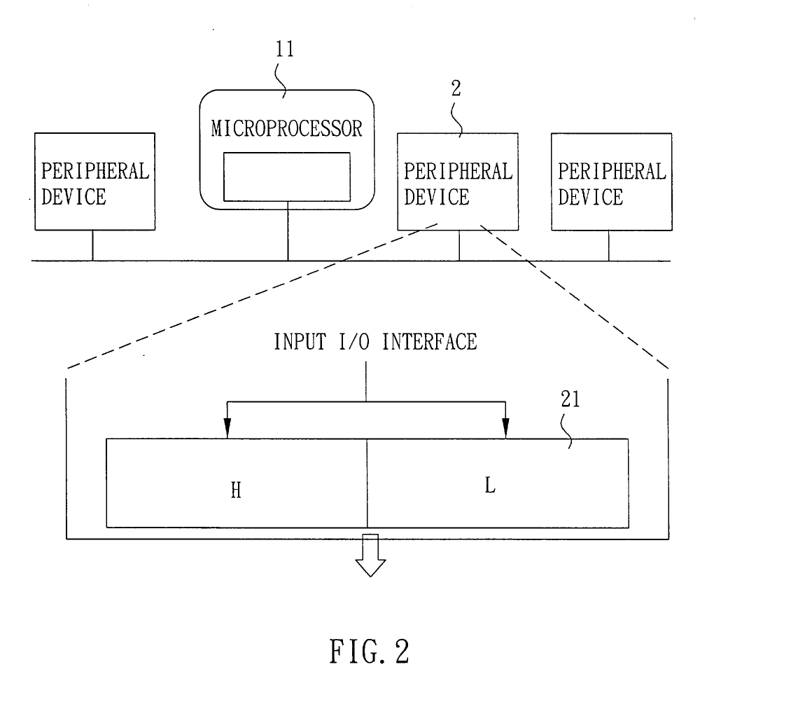

FIG. 2 schematically illustrates that the computer 1 is communicated with the peripheral device 2. The computer 1 accesses the peripheral device 2 by the second register 21 so that the microprocessor 11 accesses the data temporarily stored in the second register 21 by a data bus.

When the microprocessor 11 accesses the peripheral device 2 based on the data signal, address signal, and control signal, the microprocessor 11 or the peripheral device 2 temporarily stores the data into the first register 12 or the second register 21, and then sends the address signal and the control signal to the address decoder 3 for being decoded. The control signal is used for enabling the peripheral device 2.

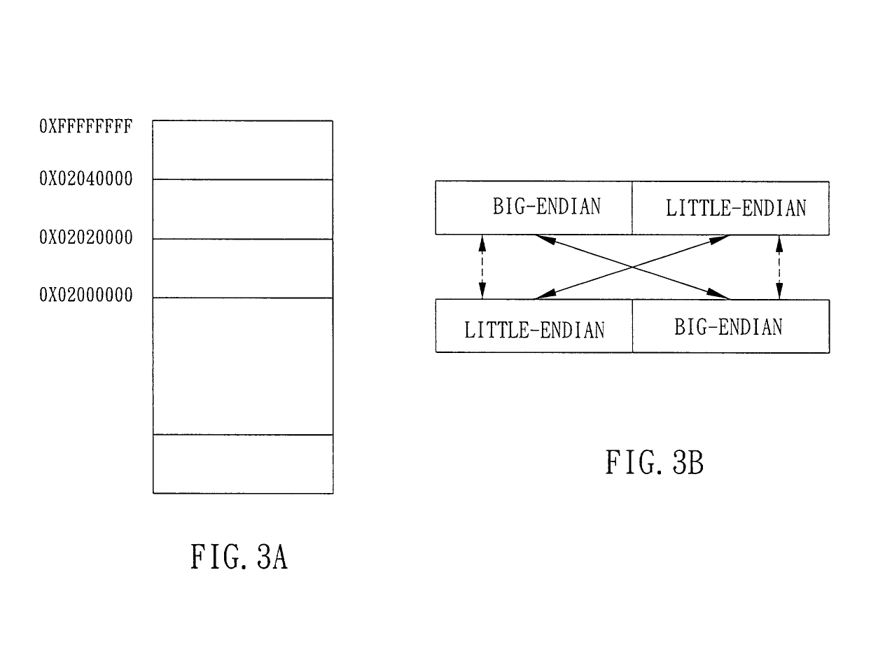

When the decoded address is at a predefined memory block, such as between addresses (i.e. 0x020200000˜0x02040000 (Referring to FIG. 1 and FIG. 3A), because the predefined memory block is the I/O read/write block of the PCMCIA card, and the endian order of the I/O read/write block is diferent from the endian order of the microprocessor 11 so that the microprocessor 11 encounter an endian error, the address decoder 3 sends an enabling signal to the endian converter 4 in order to switch the endain order of the data stored in the first register 12 or the second register 21. The predefined memory block is mapping to the I/O read/write block of the PCMCIA.

When the decoded address is at a memory block located between addresses x02000000˜0x02020000, which is the configuration block of the PCMCIA card, the endian order is the same as that of the microprocessor 11, so that the endian converter 4 does not switch the endian order of the data stored in the first register 12 or second register 21.

FIG. 3B shows the endian converter 4 for switching the endian order of the data. The endian converter 4 switches the little-endian of the first register 12 or the second register 21 to the big-endian of the second register 21 or the first register 12, and switches the big-endian of the first register 12 or the second register 21 to the little-endian of the second register 21 or the first register 12. When the endian converter 4 doesn't switch, the little-endian of the first register 12 or the second register 21 is directly accessed to the little-endian of the second register 21 or the first register 12, and the big-endian of the first register 12 or the second register 21 is directly accessed to the big-endian of the second register 21 or the first register 12.

FIG. 4 shows function block of the endian converter 4. In this embodiment, the endian converter 4 is preferably a complex programmable logic device (CPLD). The endian converter 4 has a first switching unit 41, a second switching unit 42, a third switching unit 43, and a fourth switching unit 44. The first switching unit 41 is connected to the little-endain of the first register 12 and the little-endain of the second register 21, The second switching unit 42 is connected to the big-endain of the first register 12 and the big-endain of the second register 21. The third switching unit 43 is connected to the little-endain of the first register 12 and the big-endain of the second register 21. The fourth switching unit 44 is connected to the big-endain of the first register 12 and the little-endain of the second register 21.

When the address decoder 3 receives and decodes the address signal located in the predefined memory block 0x02020000˜0x02040000, the address decoder 3 sends an enabling endian signal to the endian converter 4 to disconnect the first switching unit 41 and the second switching unit 42 and conduct the third switching unit 43 and the fourth switching unit 44, so as to write the big-endian data of the second register 21 to the little-endian of the first register 12, and write the little-endian data of the second register 21 to the big-endian of the first register 12.

When the endian converter 4 doesn't switch, the first switching unit 41 and the second switching unit 42 are conducted, and the third switching unit 43 and the fourth switching unit 44 are disconnected, so that the big-endian data of the second register 21 is directly written to the big-endian of the first register 12, and the little-endian data of the second register 21 is directly written to the little-endian of the first register 12.

In view of the foregoing, it is known that the device for automatically switching endian order of the present invention utilizes the address decoder 3 to determine whether to switch the endian based on the decoded address, and utilizes the endian converter 4 to switch the endain order for avoiding the endian error between computers and peripheral devices, thereby reducing the external instruction cycle of the microprocessor so as to increase the performance of the microprocessor.

Although the present invention has been explained in relation to its preferred embodiment, it is to be understood that many other possible modifications and variations can be made without departing from the spirit and scope of the invention as hereinafter claimed.

What is claimed is:

1. A device for automatically switching endian order between a computer and a peripheral device, the computer having a microprocessor and a first register for temporarily storing the data that the microprocessor accessed, the peripheral device having a second register for accessing the peripheral device data, the computer accessing the peripheral device based on data signal, address signal, and control signal, the device for automatically switching endian order comprising:
an address decoder for receiving and decoding the address signal from the computer to determine whether the address to be accessed by the computer is at a predefined memory space; and
an endian converter connected to the first register of the computer and the second register of the peripheral device for writing data stored in the first register to the second register, or writing data stored in the second register to the first register, wherein, when the address decoder determines that the address to be accessed by the computer is at the predefined memory space, the endian converter writes the little-endian and the big-endian of the first register to the big-endian and the little-endian of the second register, or writes the little-endian and the big-endian of the second register to the big-endian and the little-endian of the first register; otherwise, the endian converter writes the little-endian and the big-endian of the first register to the little-endian and the big-endian of the second register, or writes the little-endian and the big-endian of the second register to the little-endian and the big-endian of the first register.

2. The device for automatically switching endian order as claimed in claim 1, wherein the address decoder further receives the control signal from the computer, and, based on whether the control signal enables the peripheral device, determines whether the address to be accessed by the computer is at the predefined memory space.

3. The device for automatically switching endian order as claimed in claim 1, wherein the endian converter is a complex programmable logic device (CPLD).

4. The device for automatically switching endian order as claimed in claim 3, wherein the endian converter further comprises:
a first switch unit connected to the little-endian of the first register and the little-endian of the second register;
a second switch unit connected to the big-endian of the first register and the big-endian of the second register;
a third switch unit connected to the little-endian of the first register and the big-endian of the second register; and
a fourth switch unit connected to the big-endian of the first register and the little-endian of the second register;
wherein, when the address decoder determines that the address to be accessed by the computer is at the predefined memory space, the first switch unit and second switch unit are disconnected, and the third switch unit and the fourth switch unit are connected; otherwise, the first switch unit and second switch unit are conducted, and the third switch unit and the fourth switch unit are disconnected.

5. The device for automatically switching endian order as claimed in claim 1, wherein the peripheral device is PCMCIA card.

6. The device for automatically switching endian order as claimed in claim 5, wherein the predefined memory space is mapping to the I/O space of the PCMCIA card.
